(19) United States
(12) Patent Application Publication
(10) Pub. No.: US 2024/0001934 A1
(43) Pub. Date: Jan. 4, 2024

(54) INFORMATION PROCESSING APPARATUS AND INFORMATION PROCESSING SYSTEM

(71) Applicant: TOYOTA JIDOSHA KABUSHIKI KAISHA, Toyota-shi (JP)

(72) Inventors: Yasunao YOSHIZAKI, Tokyo-to (JP); Daisuke FURUKAWA, Tokyo-to (JP); Yui TAGAMI, Tokyo-to (JP); Tsugumi OTSUKA, Tokyo-to (JP)

(21) Appl. No.: 18/341,809

(22) Filed: Jun. 27, 2023

(30) Foreign Application Priority Data
Jun. 29, 2022 (JP) 2022-105070

(51) Int. Cl. B60W 40/09; G01C 21/34

(52) U.S. Cl. CPC B60W 40/09; G01C 21/3484; B60W 2540/221

(57) ABSTRACT

An information processing apparatus comprises a controller, the controller being configured to execute: acquiring first data about behavior of an occupant of a first vehicle during a first period from when the first vehicle leaves a point of departure until the first vehicle reaches a first point; and providing driver assistance during a second period from when the first vehicle leaves the first point until the first vehicle reaches a destination.

### CROSS REFERENCE TO THE RELATED APPLICATION

This application claims the benefit of Japanese Patent Application No. 2022-105070, filed on Jun. 29, 2022, which is hereby incorporated by reference herein in its entirety.

### BACKGROUND

### Technical Field

The present disclosure relates to a driver assistance function for vehicle.

### Description of the Related Art

There has been known a navigation apparatus for suggesting an appropriate route or destination to an occupant of a vehicle according to a situation.

In connection therewith, for example, Japanese Patent Laid-Open No. H11-337361 discloses a navigation apparatus that extracts and suggests destinations to be candidates based on weather, a season, a time zone and the like.

### SUMMARY

An object of the present disclosure is to provide appropriate driver assistance for an occupant of a vehicle.

The present disclosure in its one aspect provides an information processing apparatus comprising a controller, the controller being configured to execute: acquiring first data about behavior of an occupant of a first vehicle during a first period from when the first vehicle leaves a point of departure until the first vehicle reaches a first point; and providing driver assistance during a second period from when the first vehicle leaves the first point until the first vehicle reaches a destination.

The present disclosure in its another aspect provides an information processing system comprising an information processing apparatus associated with a first vehicle, and a mobile terminal associated with an occupant of the first vehicle, wherein the mobile terminal generates first data about behavior of the occupant; and the information processing apparatus provides, based on the first data generated by the mobile terminal during a first period from when the first vehicle leaves a point of departure until the first vehicle reaches a first point, driver assistance during a second period from when the first vehicle leaves the first point until the first vehicle reaches a destination.

As other aspects, a method executed by the above apparatus, and a program for causing a computer to execute the method or a computer-readable storage medium that non-transitorily stores the program are given.

According to the present disclosure, it is possible to provide appropriate driver assistance for an occupant of a vehicle.

### BRIEF DESCRIPTION OF THE DRAWINGS

FIG. 1 is a schematic diagram of a vehicle system according to a first embodiment;

FIG. 2 is a diagram illustrating components of a vehicle 10;

FIG. 3 is a diagram illustrating a relationship between an occupant's behavior and provided driver assistance;

FIG. 4 illustrates an example of route data stored in a storage 102;

FIG. 5 illustrates an example of facility data stored in the storage 102;

FIG. 6 illustrates an example of judgment data stored in the storage 102;

FIG. 7 is a flowchart of a process executed by an in-vehicle apparatus in the first embodiment;

FIG. 8 illustrates an example of first judgment data in a second embodiment;

FIG. 9 illustrates an example of second judgment data in the second embodiment;

FIG. 10 is a flowchart of a process executed by the in-vehicle apparatus in the second embodiment;

FIG. 11 is a schematic diagram of a vehicle system according to a third embodiment;

FIG. 12 is a diagram illustrating components of a mobile terminal 200;

FIG. 13 is a flowchart of a process executed by the in-vehicle apparatus in the third embodiment; and

FIG. 14 is a diagram illustrating a relationship between the occupant's behavior and provided driver assistance.

### DESCRIPTION OF THE EMBODIMENTS

In the field of automobiles, navigation apparatus are widespread. In general, a navigation apparatus guides a route of a vehicle from a point of departure to a destination. A navigation apparatus capable of guiding a route passing through a plurality of points is also known.

In general, a navigation apparatus makes route guidance based on a traffic situation and environment information (about weather and the like) at a current point of time.

A general navigation apparatus, however, cannot provide a suggestion based on past information. For example, a navigation apparatus capable of suggesting a drop-in point in the middle of a route is known. However, since the apparatus does not used information such as “whether the occupant has already eaten” and “how much the occupant is tired”, a case may occur where an appropriate suggestion cannot be provided.

An information processing apparatus according to the present disclosure solves such a problem.

An information processing apparatus according to one aspect of the present disclosure includes a controller, the controller being configured to execute: acquiring first data about behavior of an occupant of a first vehicle during a first period from when the first vehicle leaves a point of departure until the first vehicle reaches a first point; and providing driver assistance during a second period from when the first vehicle leaves the first point until the first vehicle reaches a destination.

The first point may be a current location of the first vehicle, or may be a point that the first vehicle is going to reach. The controller acquires data about behavior made by the occupant of the first vehicle (the first data) during the period from when the first vehicle leaves the point of departure until the first vehicle reaches the first point (the first period).

The first data may be, for example, such that is obtained by classifying the behavior made by the occupant into any of predetermined classifications. As the predetermined classifications, for example, “eating”, “shopping”, “working” and “exercising” can be exemplified.

The behavior made by the occupant during the first period can be estimated, for example, based on waypoints of the vehicle during the first period, attributes thereof, stay times and the like. The attributes of the waypoints may be judged, for example, based on map data and the like.

Further, the first data may be data about an amount of activity of the occupant. As the data about the amount of activity of the occupant, for example, the number of steps, a distance of movement on foot and calorie consumption can be exemplified. Such data can be acquired, for example, from a mobile terminal the occupant carries.

The controller provides driver assistance during the second period, based on the first data.

As the content of the driver assistance, for example, suggestion of a waypoint, adjustment of an in-vehicle environment (a driving environment) and adjustment of a driver assistance function are exemplified.

For example, if it is judged that the driver is tired, based on the behavior of the driver of the vehicle during the first period, a point where it is possible to take a break may be suggested as a new waypoint. Further, it is also possible to adjust the in-vehicle environment or the driving environment according to the condition of the driver or a passenger estimated based on a behavior history. Adjustment of the environment can be performed, for example, by transmitting data specifying an environment to an electronic control unit included in a platform of the vehicle.

When the amount of activity of the occupant is used as the first data, the content or degree of assistance may be decided according to the magnitude of the amount of activity. For example, the assistance may be provided so that, the larger the amount of activity during the first period is, the more the load on the occupant during the second period is lightened. As a method for lightening the load on the occupant, for example, a method of selecting a route where it is easier to drive, a method of selecting a route that includes a plurality of break places or a method of suggesting a sitting posture with a smaller load is exemplified.

Furthermore, when the vehicle is mounted with an advanced driver assistance system (ADAS), parameters (parameters for traveling) of the system may be decided according to the magnitude of the amount of activity. As the parameters for traveling, for example, inter-vehicle distance, cruising speed and sensor sensitivity can be exemplified. For example, if it is judged that the occupant is tired, it is possible to set the inter-vehicle distance long, expecting decrease in the reaction rate.

Specific embodiments of the present disclosure will be described below based on drawings. The hardware configuration, module configuration, functional configuration and the like described in each embodiment are not intended to limit the technological scope of the disclosure only thereto unless otherwise stated.

### First Embodiment

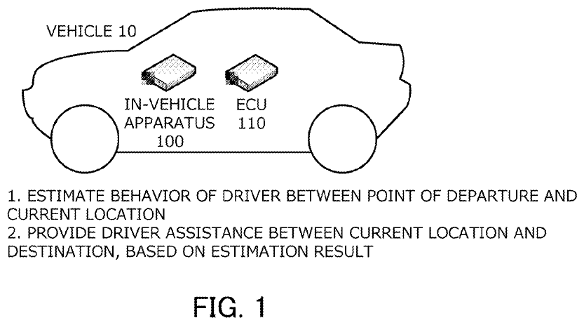

An outline of a vehicle system according to a first embodiment will be described with reference to FIG. 1. The vehicle system according to the present embodiment is configured including a vehicle 10 mounted with an in-vehicle apparatus 100 and an ECU 110.

The vehicle 10 is a connected car with a function of communicating with an external network. The vehicle 10 is configured including the in-vehicle apparatus 100 and the electronic control unit (ECU) 110. Though one ECU is exemplified in FIG. 1, the vehicle 10 can include a plurality of ECUs.

The in-vehicle apparatus 100 is an apparatus that provides information for the occupant of the vehicle 10 (for example, a car navigation apparatus). The in-vehicle apparatus 100 is also referred to as a car navigation apparatus, an infotainment apparatus or a head unit. It is possible to provide navigation and entertainment for the occupant of the vehicle 10 by the in-vehicle apparatus 100.

The ECU 110 is an electronic control unit that controls components of the vehicle 10. There may be a plurality of ECUs included in the vehicle 10. The plurality of ECUs control components of different systems, such as an engine system, an electrical system and a power train system, respectively. The ECUs have a function of generating a specified message and periodically performing transmission/reception via an in-vehicle network.

In the present embodiment, an ECU that controls electrical equipment of the vehicle 10 and an ECU that provides the advanced driver assistance system (ADAS) are exemplified as ECUs 110.

In the present embodiment, the in-vehicle apparatus 100 has a function of searching for a route from a point of departure to a destination and providing the route for the occupant of the vehicle 10. The route may include a plurality of waypoints. Moreover, the in-vehicle apparatus 100 estimates behavior of the occupant of the vehicle 10 during a period from when the vehicle 10 leaves the point of departure until the vehicle 10 reaches a current location (a first point), and decides content of driver assistance between the current location and the destination, based on a result of the estimation.

The driver assistance may be provided by the in-vehicle apparatus 100 or by the ECU 110. A method for estimating behavior of the occupant and a method for providing driver assistance will be described later.

The “occupant of the vehicle 10” in the present disclosure is typically the driver of the vehicle 10 but may be a passenger.

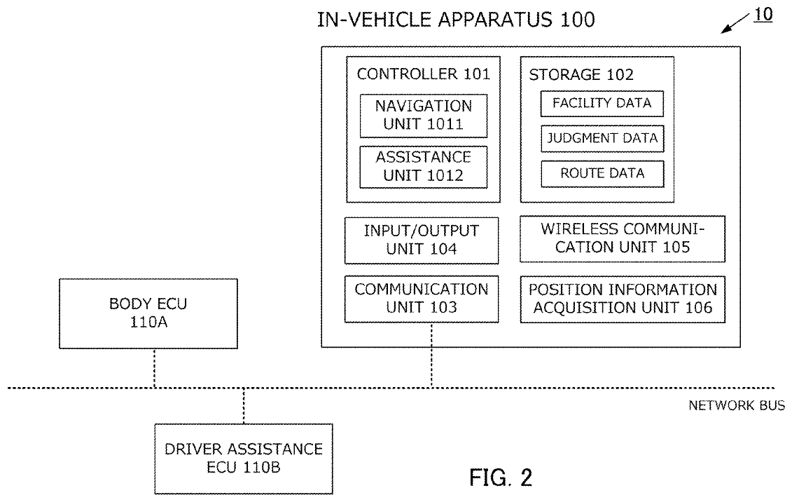

FIG. 2 is a diagram illustrating the components of the vehicle 10 according to the present embodiment. The vehicle 10 according to the present embodiment is configured including the in-vehicle apparatus 100, a body ECU 110A and a driver assistance ECU 110B.

First, the in-vehicle apparatus 100 will be described.

The in-vehicle apparatus 100 can be configured as a computer including processors such as a CPU and a GPU, a main memory such as a RAM and a ROM, and auxiliary storage devices such as an EPROM, a hard disk drive and a removable medium. In an auxiliary device, an operating system (OS), various kinds of programs, various kinds of tables and the like are stored, and, by executing a program stored therein, each of functions that are fit for predetermined purposes as described later can be realized. A part or all of the functions may be realized by a hardware circuit such as an ASIC or an FPGA.

The in-vehicle apparatus 100 is configured including a controller 101, a storage 102, a communication unit 103, an input/output unit 104, a wireless communication unit 105 and a position information acquisition unit 106.

The controller 101 is an arithmetic unit that realizes various kinds of functions of the in-vehicle apparatus 100 by executing predetermined programs. The controller 101 may be realized, for example, by a CPU or the like.

The controller 101 is configured including two function modules of a navigation unit 1011 and an assistance unit 1012. Each function module may be realized by executing a stored program by the CPU.

The navigation unit 1011 provides route guidance for the occupant of the vehicle 10. The navigation unit 1011 acquires information about a destination from the occupant of the vehicle 10 and generates a route of the vehicle 10 from a point of departure to the destination. The route may include a plurality of waypoints.

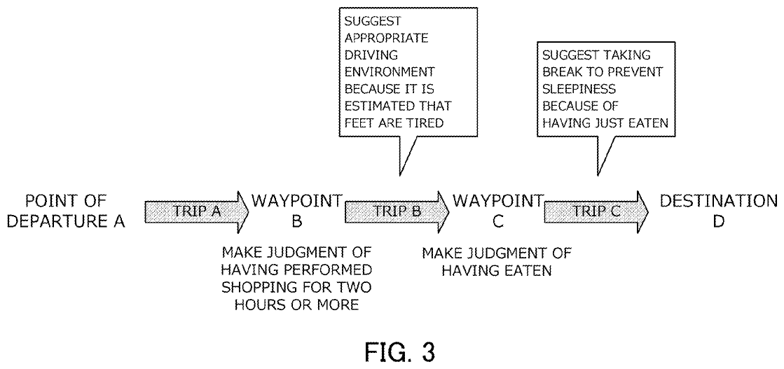

Here, the route generated by the navigation unit 1011 will be described. FIG. 3 is a schematic diagram indicating traveling of the vehicle 10 during a predetermined period (for example, one day). As illustrated, the vehicle 10 may make a plurality of trips before reaching a final destination. In the description below, the term “trip” is used as a word indicating a unit of one traveling. In this example, the vehicle 10 drops in at two waypoints after leaving a point of departure A, and reaches a destination D in the end. That is, the illustrated traveling is configured including three trips.

For example, the navigation unit 1011 acquires the destination D, which is the final destination, and searches for a route connecting the point of departure A and the destination D. In this case, waypoints B and C can be specified by the occupant of the vehicle 10 in the process of searching for the route.

In addition, each time the vehicle 10 starts a new trip, the navigation unit 1011 may sequentially search for a route corresponding the next trip. For example, the navigation unit 1011 may search for a route corresponding to a trip A (a route from A to B) at the timing of the vehicle 10 leaving the point of departure A, and search for a route corresponding to a trip B (a route from B to C) at the timing of the vehicle 10 leaving the waypoint B. By repeating this, the route to the final destination can be generated.

The navigation unit 1011 periodically acquires position information about the vehicle 10 from the position information acquisition unit 106 and accumulates the position information into the storage 102 described later.

The assistance unit 1012 estimates behavior made by the occupant during a period from when the vehicle 10 left a point of departure until the present, based on the accumulated position information, and decides content of driver assistance during a period until the vehicle 10 reaches a destination based on a result of the estimation.

For example, in the example of FIG. 3, it is assumed that a route corresponding to the trip B is searched for at the timing of the vehicle 10 leaving the waypoint B. Here, it is assumed that the assistance unit 1012 estimates that the occupant of the vehicle 10 has made behavior of “shopping” for two hours or more. Such estimation can be made based on the position information about the vehicle 10 that has been periodically acquired and accumulated. For example, if the vehicle 10 has parked at a parking lot of a shopping mall for two hours, based on data about a plurality of facilities (hereinafter, facility data), it can be estimated that the occupant of the vehicle 10 has made the behavior of “shopping” for two hours.

In this example, the assistance unit 1012 suggests a driving environment or an in-vehicle environment suitable for the condition of the occupant, based on the estimated behavior. For example, when it can be estimated that the occupant has walked for a long time, decrease in the reaction speed of feet due to tiredness is predicted. Therefore, it can be suggested to set the driver seat more forward than usual.

For example, the assistance unit 1012 outputs the content of the suggestion via the input/output unit 104, and transmits an instruction to the body ECU 110A if the occupant's consent is obtained. The instruction is, for example, to adjust positions of the driver seat, the passenger seat and the rear seat.

The assistance unit 1012 may make adjustments other than the above if the adjustments are related to the driving environment or the in-vehicle environment. For example, it is also possible to adjust temperature, ventilation and air conditioning.

Further, the assistance unit 1012 can suggest parameters of the ADAS appropriate for the condition of the occupant, based on the estimated behavior.

For example, when the occupant is tired, it is possible to suggest to set the inter-vehicle distance, which is set by cruise control, larger than usual.

For example, the assistance unit 1012 outputs the content of the suggestion via the input/output unit 104, and transmits an instruction to the driver assistance ECU 110B if the occupant's consent is obtained. The instruction is, for example, an instruction to specify parameters used for a cruise control function, an automatic brake function, an obstacle detection function, a lane keeping function, a driver monitoring function and the like.

The content of driver assistance may be other than the change in the driving environment or the in-vehicle environment, and the parameters of the ADAS. For example, the content may be to change or modify the route of the vehicle 10 to reach the destination or to suggest a new waypoint.

For example, in the example of FIG. 3, it is judged that the occupant ate at the waypoint C. In this case, in order to prevent sleepiness, it may be suggested to add a waypoint where the occupant can take a break, after a predetermined time (for example, after thirty minutes) after leaving the waypoint C. The route may be changed so that the occupant can drop in at a facility or the like where the occupant can take a break. If the occupant is tired, a route where the load on driving is lighter (for example, a main road with a wide road width, a road with few intersections or a route passing through an exclusive car road) may be re-searched for and suggested.

In this case, the assistance unit 1012 outputs the content of the suggestion via the input/output unit 104, and instructs the navigation unit 1011 to perform change of the route, addition of a waypoint or the like.

The storage 102 is configured including the main memory and the auxiliary storage devices. The main memory is a memory where programs executed by the controller 101 and data used by the program is developed. The auxiliary storage devices are devices where the programs executed by the controller 101 and the data used by the program is stored. An operating system for executing the programs may be stored in an auxiliary storage device. The functions described before are realized by the programs stored in the auxiliary storage device being loaded to the main memory and executed by the controller 101.

In the storage 102, three kinds of data, route data, facility data and judgment data, are stored in the storage 102.

The route data is data about routes that the vehicle 10 has used in the past or scheduled routes of the vehicle 10. For example, the route data is a set of pieces of position information indicating points that the vehicle 10 has passed through in the past or points that the vehicle 10 is scheduled to pass through. The route data is updated by the navigation unit 1011.

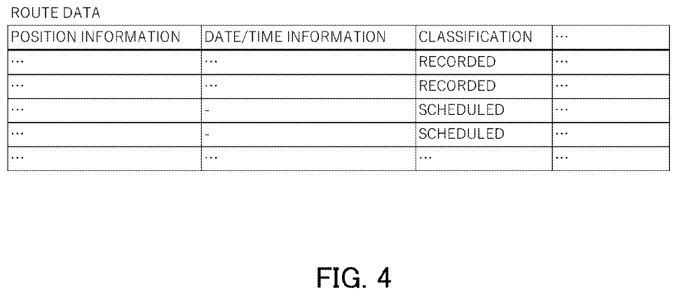

FIG. 4 illustrates an example of the route data. As illustrated, the route data is configured including pieces of position information, pieces of date/time information, and classifications. When a piece of position information indicates a point that the vehicle 10 has passed through in the past, the classification is “recorded”. When a piece of position information indicates a point that the vehicle 10 is scheduled to pass through, the classification is “scheduled”.

The point that the vehicle 10 is scheduled to pass through may be a point on a route generated by the navigation unit 1011.

The facility data is data about facilities where the vehicle 10 can drop in.

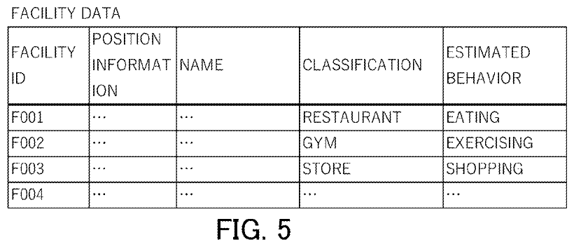

FIG. 5 illustrates an example of the facility data. As illustrated, the facility data is data in which, for each facility, an identifier, position information (a latitude and a longitude), a name, a classification, and an identifier of behavior estimated to be made at the facility are associated. By referring to the facility data, the assistance unit 1012 can estimate behavior made by the occupant of the vehicle 10 who has dropped in at a certain point.

The judgment data is data in which each piece of behavior made by the occupant of the vehicle 10 and content of driver assistance provided for the occupant are associated.

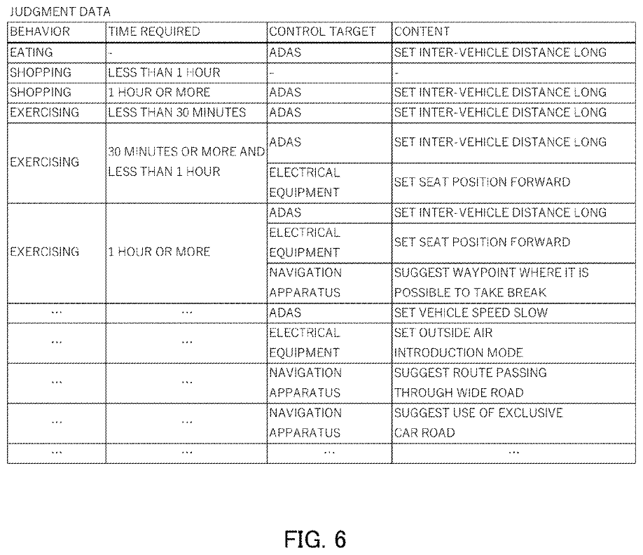

FIG. 6 illustrates an example of the judgment data. As illustrated, the judgment data includes each piece of estimated behavior, time required (time during which the behavior continued), a control target and content of driver assistance.

The control target is a subject that provides driver assistance and is, in the present embodiment, any of “ADAS”, “electrical equipment” and “in-vehicle apparatus”.

When the control target is “ADAS”, it means that driver assistance is provided by the driver assistance ECU 110B. When the control target is “electrical equipment”, it means that driver assistance is provided by the body ECU 110A. When the control target is “navigation apparatus”, it means that driver assistance is provided by the in-vehicle apparatus 100.

Returning to FIG. 2, the description will be continued.

The communication unit 103 is a communication interface that connects the in-vehicle apparatus 100 to a bus of the in-vehicle network.

The input/output unit 104 is a unit configured to accept an input operation performed by an occupant and presenting information to the occupant. Specifically, the input/output unit 104 is configured with a touch panel and a control unit therefor, and a liquid crystal display and a control unit therefor. In the present embodiment, the touch panel and the liquid crystal display are configured with one touch panel display. The input/output unit 104 may include a unit that outputs audio (an amplifier and a speaker), a unit that inputs audio (a microphone) and the like.

The wireless communication unit 105 includes an antenna and a communication module for performing wireless communication. The antenna is an antenna element that performs input/output of a wireless signal. In the present embodiment, the antenna is compatible with mobile communication (for example, 3G, LTE and 5G mobile communication). The antenna may be configured including a plurality of physical antennas. The communication module is a module for performing mobile communication.

The position information acquisition unit 106 includes a GPS antenna and a positioning module for obtaining position information. The GPS antenna is an antenna that receives a positioning signal transmitted from a positioning satellite (also referred to as a GLASS satellite). The positioning module is a module that calculates position information based on the signal received by the GPS antenna.

The network bus is a communication bus constituting the in-vehicle network. Though one bus is exemplified in this example, the vehicle 10 may include two or more communication buses. The plurality of communication buses may be mutually connected via a gateway to which the plurality of communication buses are connected.

Next, content of driver assistance that the vehicle 10 can provide will be described.

As described before, driver assistance can be provided using the in-vehicle apparatus 100, the electrical equipment of the vehicle 10 or the ADAS.

As driver assistance provided by the in-vehicle apparatus 100, the following can be exemplified:
(A1) To change a scheduled route to a route that passes through an exclusive car road
(A2) To change a scheduled route to a route that passes through a road with a wide road width (a main road)
(A3) To add a waypoint where the occupant can take a break

As driver assistance provided using the electrical equipment of the vehicle 10, the following can be exemplified:
(B1) To set a seat position that makes a driving posture comfortable
(B2) To set a seat position that makes it easy to step on a pedal
(B3) To switch the air-conditioning mode (for example, switching from an inside air circulation mode to an outside air introduction mode to prevent sleepiness)
(B4) To use a seat massage function

As driver assistance provided using the ADAS of the vehicle 10, the following can be exemplified:
(C1) Use of cruise control
(C2) To set the inter-vehicle distance long
(C3) To set the cruising speed low

The assistance unit 1012 transmits instructions to perform the above driver assistances to corresponding devices. Before giving each of the above instructions, the assistance unit 1012 may suggest content of driver assistance to the occupant of the vehicle 10 to obtain his answer. If the occupant consents to the suggestion, the data described before is transmitted to each component.

For example, when it is estimated that the driver is tired or when it is estimated that the driver is in a state of easily becoming sleepy, it is possible to reduce the load on driving or improve the margin for safety by providing the driver assistance described before.

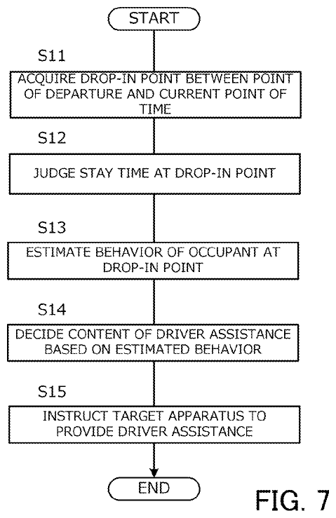

Next, description will be made on a process for the in-vehicle apparatus 100 to estimate behavior of the occupant of the vehicle 10 and execute driver assistance based on the estimated behavior. FIG. 7 is a flowchart of the process executed by the in-vehicle apparatus 100. The illustrated process is executed by the assistance unit 1012 at a predetermined timing. The predetermined timing may be, for example, a periodical timing or a timing when the occupant of the vehicle 10 newly executes route search.

First, at step S11, a drop-in point (a waypoint) where the vehicle 10 dropped in during a period from when the vehicle 10 left the point of departure until the current point of time is acquired. The point where the vehicle 10 dropped in can be judged based on the route data stored in the storage 102.

At this step, the point where the vehicle 10 dropped in during a period from when the vehicle 10 left the point of departure until the current point of time is judged by comparing temporal transition of position information indicated by the route data with the facility data.

The point of departure of the vehicle 10 can be, for example, a point at which the vehicle 10 starts movement for the first time within the same day.

At step S12, a stay time at the drop-in point is judged. Time during which the vehicle 10 and the occupant stayed at a certain point can be judged based on time-series position information included in the route data.

Next, at step S13, behavior of the occupant at the drop-in point is estimated. Estimation of the behavior can be performed based on the attribute of the drop-in point indicated in the facility data and the stay time. For example, if the route data indicates that the vehicle 10 stopped for forty-five minutes at a parking lot of a sports gym, it is estimated that behavior of “exercising (more than thirty minutes and less than one hour) was made. In the description below, “behavior” is assumed to be a combination of a behavior classification, such as eating, shopping or exercising, and stay time.

Next, at step S14, content of driver assistance corresponding to the estimated behavior is decided. Decision of the content of driver assistance can be performed based on the judgment data stored in the storage 102.

If the occupant of the vehicle 10 has made a plurality of pieces of behavior in the past driving process, driver assistance corresponding to any of the pieces of behavior may be provided, or all of pieces of corresponding driver assistance may be provided.

Next, at step S15, a process for executing the decided driver assistance is performed. At this step, the assistance unit 1012 transmits data that includes the content of the driver assistance to a subject that provides the driver assistance.

For example, if it is judged that the behavior of “exercising (more than thirty minutes and less than one hour)” has been made in the example of FIG. 6, the driver assistance ECU 110B performs control to set the inter-vehicle distance long, and the body ECU 110A sets the position of the driver seat forward.

As described above, a vehicle system in the first embodiment decides, based on behavior made by an occupant of a vehicle in a driving process from when the vehicle started traveling until the present, content of driver assistance to be provided for the occupant in the subsequent driving process. According to such a configuration, it becomes possible to provide appropriate support according to the condition (for example, a tired condition) of the occupant.

### Second Embodiment

In the first embodiment, behavior of the occupant made at a certain waypoint is estimated, and driver assistance in the next trip is provided based on the estimated behavior.

However, since physical tiredness and the like are gradually accumulating, a case may occur where it is not appropriate to decide whether or not to provide driver assistance based on a single piece of behavior (for example, “shopping”) made at a certain point.

In order to cope with this, the in-vehicle apparatus 100 estimates a cumulative amount of activity of the occupant up to the current point of time, and decides whether or not to provide driver assistance, and content of the driver assistance based on the estimated amount of activity in a second embodiment. The amount of activity refers to a value indicating an amount of physical activity. In the second embodiment, the amount of activity is used as an evaluation value for deciding whether or not to provide driver assistance, and content of the driver assistance.

In the second embodiment, the judgment data stored in the storage 102 is configured with first judgment data and second judgment data. The first judgment data is data in which each piece of behavior made by the occupant is associated with an amount of activity, and the second judgment data is data in which each amount of activity is associated with content of driver assistance.

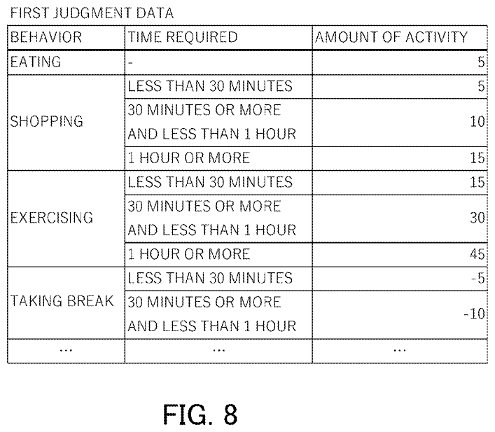

FIG. 8 illustrates an example of the first judgment data in the second embodiment. In the first judgment data, each piece of behavior and time required therefor are associated with a numerical value indicating an amount of activity. The amount of activity in the present system is a value indicating intensity of physical activity, and, the higher the intensity of physical activity is, the larger the defined value is. By summing up such values, a degree of tiredness of a person in a day can be estimated. If behavior made by the occupant includes a break, a minus amount of activity may be associated. Thereby, recovery from tiredness can be expressed.

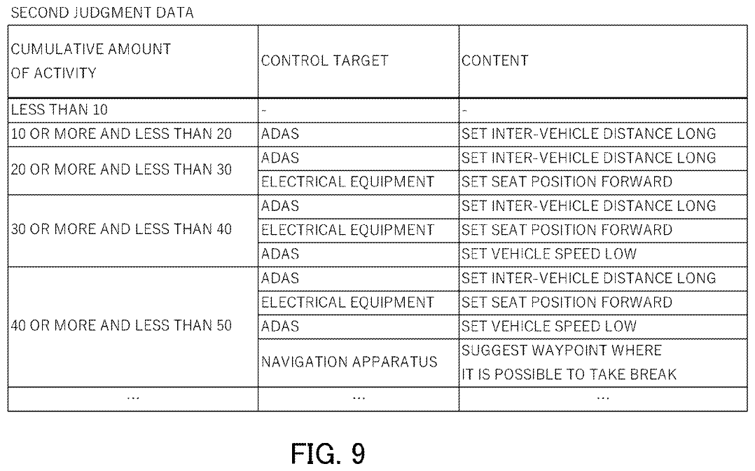

FIG. 9 illustrates an example of the second judgment data. In the second judgment data, content of driver assistance to be provided is associated with each cumulative amount of activity. In this example, content of driver assistance is defined so that, the more the cumulative amount of activity increases, the more the load on driving is lightened. By referring to the first judgment data and the second judgment data, it becomes possible to calculate a cumulative value of amounts of activity corresponding to the occupant of the vehicle 10, and it becomes possible to decide content of driver assistance corresponding to the cumulative value.

Though it is exemplified to suggest taking a break as content of assistance in the example of FIG. 9, break places and the number of breaks may be decided according to the cumulative value of amounts of activity. Further, change to a route with a lower driving load may be made according to the cumulative value of amounts of activity.

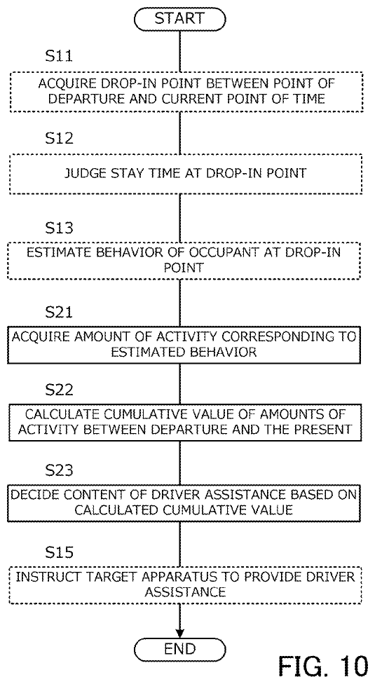

FIG. 10 is a flowchart of a process executed by the in-vehicle apparatus 100 in the second embodiment. Processes similar to those of the first embodiment are indicated by broken lines, and description thereof will be omitted.

In the second embodiment, after estimating behavior of the occupant at step S13, an amount of activity corresponding to the estimated behavior is calculated.

At step S21, the amount of activity corresponding to the estimated behavior is acquired. For example, in the case of the example of FIG. 8, when exercise is taken for forty-five minutes, a corresponding amount of activity is “30”. Amounts of activity may be defined by such a table as illustrated or may be calculated using a formula, a machine learning model or the like.

Next, at step S22, a cumulative value of amounts of activity during a period from when the vehicle 10 left a point of departure until the present is calculated. For example, in the example of FIG. 3, if the vehicle 10 is located at the waypoint B, an amount of activity corresponding to behavior made at the waypoint B is calculated. If the vehicle 10 is located at the waypoint C, a total of the amount of activity corresponding to the behavior made at the waypoint B and an amount of activity corresponding to behavior made at the waypoint C is calculated. The obtained cumulative value is a value corresponding to a total amount of physical activity made by the occupant of the vehicle 10 in the driving process of one day.

Next, at step S23, content of driver assistance in the subsequent trip is decided based on the calculated cumulative value. For example, in the example of FIG. 9, if the cumulative amount of activity is “25”, the assistance unit 1012 decides to provide driver assistance of “setting the inter-vehicle distance long” and “setting the seat position forward”.

As described above, according to the second embodiment, it is possible to, based on an amount of activity of the occupant of the vehicle 10 during a period from when the vehicle 10 started traveling until the present, decide content of driver assistance to be provided for the occupant. Thereby, it becomes possible to provide driver assistance considering accumulation of and recovery from tiredness.

### Third Embodiment

In the second embodiment, behavior made by the occupant is estimated based on a point where the vehicle 10 dropped in, and an amount of activity corresponding to the behavior is acquired. In comparison, a third embodiment is an embodiment in which data about physical activity is acquired from a mobile terminal that the occupant carries, and an amount of activity of the occupant is calculated using the data.

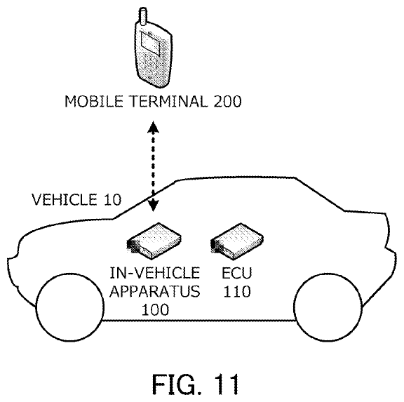

FIG. 11 is a schematic diagram of a vehicle system in the third embodiment. As illustrated, in the third embodiment, the in-vehicle apparatus 100 is configured to be wirelessly communicable with a mobile terminal that the occupant of the vehicle 10 carries (a mobile terminal 200).

The mobile terminal 200 is a computer capable of acquiring and providing data about physical activity performed by the occupant. The mobile terminal 200 is a small-size computing device such as a smartphone, a tablet computer, a wearable computer or the like. The mobile terminal 200 has a function of acquiring data about physical activity. As the data about physical activity, for example, the number of steps, a movement distance, a heart rate and estimated calorie consumption are exemplified.

The in-vehicle apparatus 100 makes a judgment about an amount of activity of the occupant associated with the mobile terminal 200, based on the data about physical activity acquired from the mobile terminal 200.

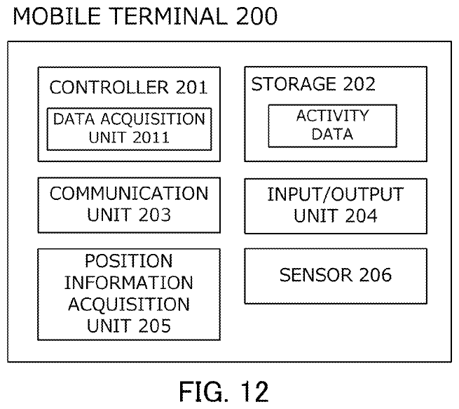

FIG. 12 is a diagram illustrating components of the mobile terminal 200 in the third embodiment.

Similarly to the in-vehicle apparatus 100, the mobile terminal 200 can be configured as a computer including processors such as a CPU and a GPU, a main memory such as a RAM and a ROM, and auxiliary storage devices such as an EPROM, a hard disk drive and a removable medium. A part or all of the functions may be realized by a hardware circuit such as an ASIC or an FPGA.

The mobile terminal 200 is configured including a controller 201, a storage 202, a communication unit 203, an input/output unit 204, a position information acquisition unit 205 and a sensor 206.

Here, the sensor 206 will be described first.

The sensor 206 is a set of one or more sensors that sense data about physical activity of the occupant. As such sensors, for example, a step sensor, a heartbeat sensor and an acceleration sensor are exemplified. For example, by acquiring an acceleration on each of three-dimensional axes, it is possible to judge how intense exercise the occupant who carries the mobile terminal 200 is taking.

The controller 201 is an arithmetic unit that realizes various kinds of functions of the mobile terminal 200 by executing predetermined programs. The controller 201 may be realized, for example, by a CPU or the like.

The controller 201 is configured including a data acquisition unit 2011 as a function module. The function module may be realized by executing a stored program by the CPU.

The data acquisition unit 2011 generates data about physical activity (hereinafter, activity data) of the occupant based on sensor data acquired from the sensor 206.

As the sensor data, for example, an acceleration and a heart rate can be exemplified. As the activity data, for example, the number of steps, a distance of movement on foot and calorie consumption during a predetermined period can be exemplified.

The data acquisition unit 2011 periodically acquires and accumulates the activity data, and transmits the activity data to the in-vehicle apparatus 100 at a predetermined timing. As the predetermined timing, for example, a timing when the occupant gets into the vehicle 10 can be exemplified.

The storage 202 is configured including the main memory and the auxiliary storage devices. The main memory is a memory where programs executed by the controller 201 and data used by the program is developed. The auxiliary storage devices are devices where the programs executed by the controller 201 and the data used by the program is stored. An operating system for executing the programs may be stored in an auxiliary storage device. The functions described before are realized by the programs stored in the auxiliary storage device being loaded to the main memory and executed by the controller 201. Further, the activity data described before is stored in the storage 202.

The communication unit 203 is a wireless communication interface for connecting the mobile terminal 200 to a network. The communication unit 203 includes an antenna for performing wireless communication, and a communication module for performing mobile communication. In the present embodiment, the antenna is compatible with mobile communication (for example, 3G, LTE and 5G mobile communication).

Though mobile communication is exemplified here, the in-vehicle apparatus 100 and the mobile terminal 200 may perform communication via near-field wireless communication or the like.

The input/output unit 204 is a unit configured to accept an input operation performed by the occupant and presenting information to the occupant. Specifically, the input/output unit 104 is configured with a touch panel and a control unit therefor, and a liquid crystal display and a control unit therefor. In the present embodiment, the touch panel and the liquid crystal display are configured with one touch panel display.

The position information acquisition unit 205 includes a GPS antenna and a positioning module for obtaining position information. The GPS antenna is an antenna that receives a positioning signal transmitted from a positioning satellite (also referred to as a GLASS satellite). The positioning module is a module that calculates position information based on the signal received by the GPS antenna.

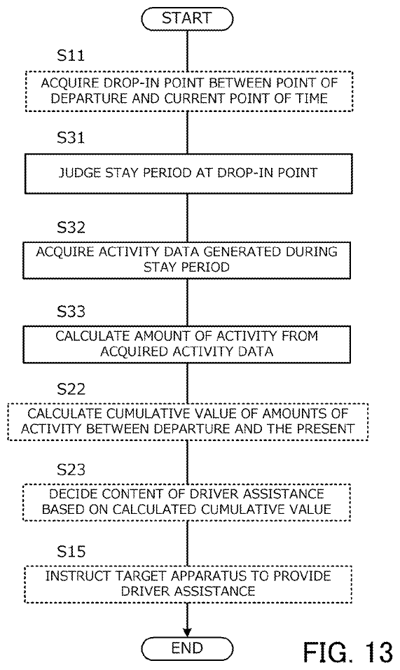

FIG. 13 is a flowchart of a process executed by the in-vehicle apparatus 100 in the third embodiment. Processes similar to those of the second embodiment are indicated by broken lines, and description thereof will be omitted.

In the third embodiment, activity data is received from the mobile terminal 200 after acquiring a drop-in point of the vehicle 10 at step S11, and an amount of activity of the occupant at the drop-in point is calculated based on the activity data.

First, at step S31, a stay period (that is, a period during which the vehicle 10 parked) at the drop-in point is judged. The stay period can be judged, for example, based on route data (periodically acquired position information about the vehicle 10).

At this step, for example, it is judged that the vehicle 10 stayed at a certain point from 9:00 in the morning till 10:00 in the morning.

At step S32, communication is performed with the mobile terminal 200, and activity data generated during the stay period is acquired. For example, in the above example, activity data generated during the period from 9:00 in the morning till 10:00 in the morning is received from the mobile terminal 200.

Next, at step S33, an amount of activity is calculated based on the activity data. At this step, it is necessary to convert values indicated by the activity data (for example, the number of steps, a distance of movement on foot and calorie consumption) to an amount of activity in the present system. Therefore, the in-vehicle apparatus 100 may store conversion rules for converting activity data received from the mobile terminal 200 to an amount of activity used in the present system.

The process at and after step S22 is similar to that of the second embodiment.

As described above, according to the third embodiment, data about an amount of activity of the occupant of the vehicle 10 is acquired from the mobile terminal 200 that the occupant carries and is used for judgment. Though an amount of activity is estimated based on the classification of a facility and the stay time in the second embodiment, it becomes possible to estimate an amount of activity close to an actual amount of activity by using activity data.

Though only activity data acquired from the mobile terminal 200 is used to calculate an amount of activity in the present embodiment, the amount of activity may be calculated using other data together.

For example, if a facility where the occupant of the vehicle 10 drops in is a sports gym, the occupant may take exercise without carrying the mobile terminal 200. In such a case, an amount of activity assumed from the stay time may be inconsistent with an amount of activity indicated by activity data. In such a case, the amount of activity may be estimated using data other than the activity data (for example, the attribute of the facility and the stay time).

Further, an amount of activity may be calculated using both of other data and activity data acquired from the mobile terminal 200. For example, amounts of activity may be calculated by the method exemplified in the second embodiment and the method exemplified in the third embodiment, respectively, and the amounts may be integrated. The amount of activity calculated by the method of the second embodiment may be corrected using the activity data acquired from the mobile terminal 200.

### Fourth Embodiment

In the first to third embodiments, based on behavior made by the occupant during the period from departure of the vehicle 10 until the current time, and the like, content of driver assistance in the subsequent driving process is decided. Behavior of an estimation target, however, is not limited to behavior in the past.

There may be a case where behavior of the occupant in the future can be estimated, for example, a case where a plurality of waypoints to drop in at between a point of departure and a destination are already set for the navigation apparatus.

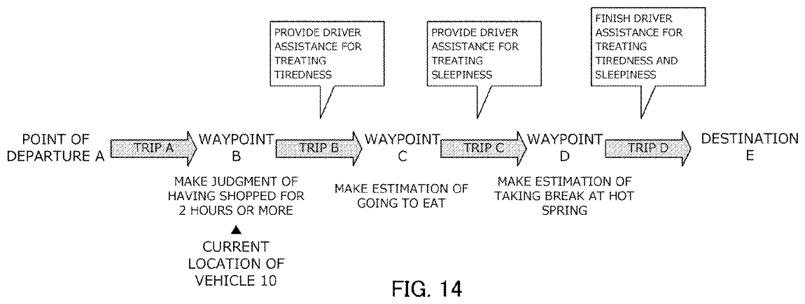

FIG. 14 is a diagram exemplifying a plurality of waypoints during a period from when the vehicle 10 leaves the point of departure A until the vehicle 10 reaches a destination E. In this example, it is assumed that the vehicle 10 is located at the waypoint B. Further, it is assumed that waypoints C and D are set for the in-vehicle apparatus 100 as scheduled waypoints. In this case, the in-vehicle apparatus 100 decides content of driver assistance in the trip B based on behavior at the waypoint B.

Furthermore, content of driver assistance in the trip C can be decided beforehand based on behavior of the occupant in the future. In this example, for example, it can be estimated that “the occupant is going to eat at the waypoint C because the attribute of the waypoint C is restaurant.” In this case, it can be decided beforehand, for example, to provide driver assistance for treating sleepiness in the trip C.

Similarly, content of driver assistance in a trip D can be decided beforehand based on behavior of the occupant in the future. In this example, for example, it can be estimated that “the occupant is going to take a break at the waypoint D because the attribute of the waypoint D is hot spring facility”. In this case, it can be decided beforehand, for example, to finish provision of the driver assistance for treating tiredness and sleepiness in the trip D.

Thus, a period for which behavior of the occupant and the like are to be estimated is not limited to a period from departure of the vehicle 10 until the present but may be a period from departure of the vehicle 10 until a predetermined timing in the future.

(Modification)

The above embodiments are mere examples, and the present disclosure can be appropriately changed and practiced within a range not departing from the spirit thereof.

For example, the processes and means described in the present disclosure can be freely combined and implemented as far as a technical contradiction does not occur.

Further, though content of driver assistance is decided based on behavior of the occupant at “a drop-in point of the vehicle 10” in the description of the embodiments, content of driver assistance may be decided, further using other data about behavior, activity or exercise of the occupant in the past. For example, content of driver assistance may be decided in consideration of the traveling distance, traveling time or continuous driving time and the like of the vehicle 10.

Moreover, if audio in the vehicle 10 can be acquired, a judgment about the degree of tiredness, sleepiness, condition and the like of the occupant may be judged based on the acquired audio. For example, a calculated amount of activity may be corrected based on an utterance included in the audio. Further, content of driver assistance to be provided may be changed based on a result of the judgment.

Further, though the occupant of the vehicle 10 is assumed to be a driver in the description of the embodiments, content of services to be provided for a passenger may be decided based on behavior and the like of the passenger. For example, a degree of tiredness of the passenger may be judged based on activity data acquired from a mobile terminal 200 that the passenger carries to provide assistance corresponding to the degree of tiredness of the passenger. As the assistance corresponding to the degree of tiredness, adjustment of a seat position, provision of a massage function, provision of a ventilation function, setting of a reclining angle or provision of a seat heating function can be exemplified.

Processing described as being performed by one apparatus may be shared and executed by a plurality of apparatuses. Or alternatively, processing described as being performed by different apparatuses may be executed by one apparatus. In a computer system, what hardware configuration (server configuration) each function is realized by can be flexibly changed.

The present disclosure can be realized by supplying a computer program implemented with the functions described in the above embodiments to a computer, and one or more processors that the computer has reading out and executing the program. Such a computer program may be provided for the computer by a non-transitory computer-readable storage medium connectable to a system bus of the computer or may be provided for the computer via a network. As the non-transitory computer-readable storage medium, for example, a disk of a given type such as a magnetic disk (a floppy (R) disk, a hard disk drive (HDD) and the like) and an optical disc (a CD-ROM, a DVD disc, a Blu-ray disc and the like), a read-only memory (ROM), a random-access memory (RAM), an EPROM, an EEPROM, a magnetic card, a flash memory, an optical card, and a medium of a given type that is appropriate for storing electronic commands are included.

What is claimed is:

1. An information processing apparatus comprising a controller, the controller being configured to execute:
acquiring first data about behavior of an occupant of a first vehicle during a first period from when the first vehicle leaves a point of departure until the first vehicle reaches a first point; and
providing driver assistance during a second period from when the first vehicle leaves the first point until the first vehicle reaches a destination.

2. The information processing apparatus according to claim 1, wherein
the controller decides a driving environment for the first vehicle during the second period, based on the first data, and transmits data specifying the decided driving environment to a platform of the first vehicle.

3. The information processing apparatus according to claim 1, wherein
the controller decides parameters for an advanced driver assistance system (ADAS) of the first vehicle during the second period, based on the first data, and applies the decided parameters to the ADAS.

4. The information processing apparatus according to claim 1, wherein
the controller decides a waypoint of the first vehicle during the second period based on the first data.

5. The information processing apparatus according to claim 1, wherein
the controller estimates the behavior of the occupant during the first period, based on a first waypoint which is a waypoint of the first vehicle during the first period.

6. The information processing apparatus according to claim 5, wherein
the controller judges an attribute of the first waypoint based on facility data, and estimates the behavior of the occupant based on the judged attribute.

7. The information processing apparatus according to claim 6, wherein
the controller estimates the behavior of the occupant further based on a stay time at the first waypoint.

8. The information processing apparatus according to claim 1, wherein
the controller calculates an evaluation value indicating an amount of activity of the occupant during the first period, based on the first data.

9. The information processing apparatus according to claim 8, wherein
the controller calculates the evaluation value further based on activity amount information acquired from a mobile terminal associated with the occupant.

10. The information processing apparatus according to claim 9, wherein
the activity amount information includes at least either the number of steps or a distance of movement on foot.

11. The information processing apparatus according to claim 8, wherein
the controller calculates the evaluation value further based on an utterance of the occupant detected in the first vehicle.

12. The information processing apparatus according to claim 8, wherein
the controller decides content of the driver assistance during the second period so that, the larger the amount of activity indicated by the evaluation value is, the smaller a load on the occupant during the second period is.

13. The information processing apparatus according to claim 8, wherein
when the amount of activity indicated by the evaluation value exceeds a predetermined value, the controller changes a scheduled route of the first vehicle during the second period to a second scheduled route with a smaller load on the occupant.

14. The information processing apparatus according to claim 13, wherein
the second scheduled route is a route including one or more break places decided based on the amount of activity indicated by the evaluation value.

15. The information processing apparatus according to claim 8, wherein
the controller decides a driving position of the occupant during the second period, based on the amount of activity indicated by the evaluation value.

16. The information processing apparatus according to claim 8, wherein
the controller decides parameters of an advanced driver assistance system (ADAS) of the first vehicle during the second period, based on the amount of activity indicated by the evaluation value.

17. An information processing system comprising an information processing apparatus associated with a first vehicle, and a mobile terminal associated with an occupant of the first vehicle, wherein
the mobile terminal generates first data about behavior of the occupant; and
the information processing apparatus provides, based on the first data generated by the mobile terminal during a first period from when the first vehicle leaves a point of departure until the first vehicle reaches a first point, driver assistance during a second period from when the first vehicle leaves the first point until the first vehicle reaches a destination.

18. The information processing system according to claim 17, wherein
the first data is data about an amount of activity.

19. The information processing system according to claim 18, wherein
the first data is data about any of the number of steps, a distance of movement on foot and calorie consumption.

20. The information processing system according to claim 18, wherein
the information processing apparatus decides content of the driver assistance during the second period so that, the larger the amount of activity is, the smaller a load on the occupant during the second period is.
